(19) United States
(12) Patent Application Publication
(10) Pub. No.: US 2013/0152567 A1
(43) Pub. Date: Jun. 20, 2013

(54) Liquid gas power generation

(71) Applicant: Scott Clair Pockrandt, Ridgecrest, CA (US)

(72) Inventor: Scott Clair Pockrandt, Ridgecrest, CA (US)

(21) Appl. No.: 13/694,433

(22) Filed: Dec. 3, 2012

Related U.S. Application Data
(60) Provisional application No. 61/630,320, filed on Dec. 9, 2011.

(51) Int. Cl. F15B 15/00

(52) U.S. Cl. CPC F15B 15/00
USPC 60/327

(57) ABSTRACT

The Lungie Pet Leash system uses an elastic material attached to a static control leash to: reduce and/or eliminate the effects of sudden impact, hyper-extension or other forces caused by a pet's movements; avoid being pulled off balance, or injured; prevent or lessen injury to a pet from sudden stopping during a full tilt run.

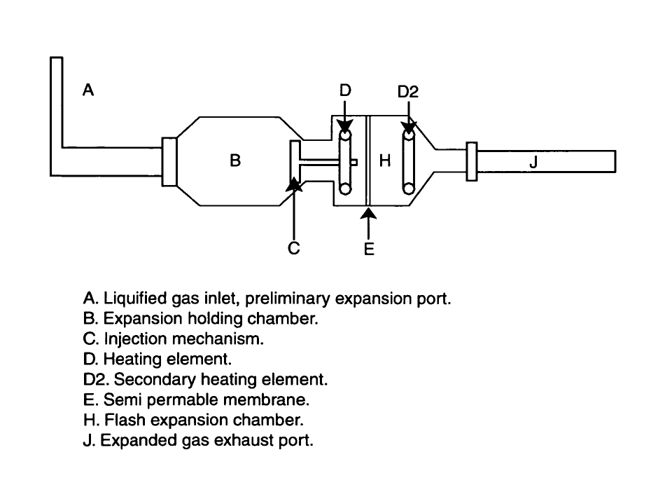

The system allows for control and training of a creature without having the control associated directly with the trainer.

The optional configuration allows for choice to use direct control without the shock absorbing feature.

In all applications the Lungie is attachable to an existing restraint provided by the end user.

Applications include, but are not limited to, control and protection of children, animals and other creatures requiring handling.

This application claims priority from Provisional Application No. 61/630,320 Issued Dec. 9, 2011

### FERDERALLY SPONSORED RESERACH

Not applicable.

### SEQUENCE LISTING OR PROGRAM

Not applicable.

Submission of Drawing and description.

The following paragraphs describe the operation of the Lungie Pet Leash, and explains the drawings.

Drawing 1:

Liquified gas is delivered to the system by inlet (A), which provides for an initial/primary expansion. The gas is delivered into the expansion holding chamber (B) which acts as a bellows and stabilizes pressure for application to the Injection Mechanism (C).

Injection Mechanism (C) is controlled to allow greater or lesser amounts liquified gas to be applied to the heating element (D).

Heating element (D) heats the liquified gas to a fully gaseous form. The expansion ratio depends upon the liquid to gas expansion ratio of the gas used. Note that the gas is not combined with any other material, and is not “burned” it is expanded by the application of heat.

The semi-permeable membrane (E) is optional, and can be used, depending upon the gas applied, to prevent back pressure of the expanded gas.

The expanded gas moves toward the Expanded Gas Exhaust Port (J) due to differentiation of pressure.

In certain applications, a Secondary Heating Element (D2) can be used (optional) for further expansion, to combine other applied gasses

The gas then passes out through the Expanded Gas Exhaust Port (J) to be applied to generate electrical, mechanical or other forms of energy, by application to external devices which are chosen by the end user.

1: I have developed a process and method which uses any gas which can be liquefied, in liquid and “operating-pressure” forms, to provide for the generation of motive force, to be applied as necessary to produce movement, generation of electricity, and other forms of mechanical, electrical and/or other forms of energy.

2: I have developed a process and method that produces no greenhouse gas emissions, uses no Oxygen and does not create an additional burden on the commercial power grid, or secondary sources of energy that depend on fossil fuels for operation to produce motive power.
Current systems rely mostly on the burning of fossil fuels to produce motive force¹ which is then used to drive wheels, lift weights, etc. This is a loss system, which produces waste heat, carbon compounds, and is not energy efficient.
¹ Motive force is a term used throughout to describe a directed moving energy flow, this can be rotating, push-pull, or any other type of motion required to accomplish the goals set (e.g. a rotary motion for a dynamo producing electricity).
Those which utilize Hydrogen as a fuel, have the added energy cost of production of Hydrogen by “cracking” water, and then recombining with Oxygen in a combustion which is colorless, but extremely hot. Further, Hydrogen is an extremely explosive gas at normal atmospheric pressure, as was demonstrated by the explosion at the nuclear facility in Japan.
The proposed system utilizes any passively filtered gas which is cooled to liquid form and then expanded to “working pressure”² as needed. The gas is not burned, and requires no combustion or combination chemicals to operate.
² Working pressure is defined as the pressure needed to produce the required motive force, and which is regulated by the system in which it is applied.
Any gas available in the atmosphere, or in space, and which can be liquefied, can be used in this system. For example the expansion rate of Nitrogen is 1:694 at 20 C, a tremendous amount of force can be generated if liquid nitrogen is rapidly. vaporized.
Liquid Nitrogen has a very low viscosity rating, and thus there is no additional force needed for delivery to the expansion chamber. This will allow for use of a very small portion of the expanded gas pressure to activate the system and deliver the necessary flow for the system to operate. Liquid Nitrogen approaches the “ideal liquid” status: Liquid Nitrogen at 77 degrees Kelvin has a viscosity of only 1.58×10⁻⁴ or 0.158 Alternatively, a vacuum or slight overpressure can be used to activate the injection of the Liquid Nitrogen into the system.
The liquefied gas is will not be held under pressure, and is contained without danger of explosion. Nitrogen can be easily stored as a solid, by a simple and effective, currently used vacuum system, allowing for even more mechanical energy to be developed, while still maintaining safety.
The application of this process and method, is not a “common usage” or “obvious” use of the materials involved. There is no other system which takes advantage of the materials a processes as set forth in my system.
The components listed in this application constitute the full system as designed for use in an existing or newly constructed generation facility, are set forth as an example of the use of the process and method, and are not exhaustive or all inclusive.
This filing refers to Provisional Patent No. 61/630,320, filed by Scott Clair Pockrandt, and issued on Dec. 9, 2011.
